(19) United States
(12) Patent Application Publication
(10) Pub. No.: US 2007/0241575 A1
(43) Pub. Date: Oct. 18, 2007

(54) Vacuum Tube Lift Device and a Method for Movement of a Load by Means of a Vacuum Tube Lift

(75) Inventor: Anders Lundin, Goteborg (SE)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Vaculex AB, Molndal (SE)

(21) Appl. No.: 11/596,965

(22) PCT Filed: Apr. 14, 2005
(86) PCT No.: PCT/SE05/00531

§ 371 Date: Nov. 17, 2006

(30) Foreign Application Priority Data
May 18, 2004 (SE) 0401312-4

(51) Int. Cl. B66C 1/02

(52) U.S. Cl. 294/64.1

(57) ABSTRACT

A vacuum tube lift device includes a lifting tube (1), the lifting tube (1) having a first end (2) for attachment of the lifting tube (1) and a second end (5) for connection to a means (6) for coupling the lifting tube (1) to a load (7). The lifting tube (1) is adapted for connection to a vacuum source (3) and is extendable and retractable in order to achieve an extending or retracting movement of the lifting tube (1) for movement of a load (7) by means of regulating the pressure inside the lifting tube (1). Furthermore, the device includes at least one supporting unit (15) providing at least one point of support (36), and at least one extendable and retractable portion (16) of the lifting tube (1) is arranged to support itself on the point of support (36) and to travel over the point of support (36) during an extending or retracting movement of the lifting tube (1), for movement of said extendable and retractable portion (16) in a first direction (13a) on a first side (17) of the point of support (36) and in a second direction (14a), being different from the first direction (13a), on a second side (18) of the point of support (36).

### FIELD OF THE INVENTION

The present invention relates to a vacuum tube lift device in accordance with the preamble of claim 1 and a method in accordance with the preamble of claim 20.

### BACKGROUND OF THE INVENTION AND PRIOR ART

Conventional vacuum tube lift devices have a flexible, vertically disposed lifting tube, being suspended at its upper end and connected to a vacuum source for regulating the pressure in the lifting tube. Some kind of lifting attachment is arranged at the lower end of the lifting tube. The lifting attachment can be a hook or a suction cup, or the like, which can be coupled to a load which is to be lifted.

Furthermore, the lifting tube is extendable and retractable, i.e. the lifting tube can be compressed and extended in its longitudinal direction (vertically). Accordingly, the lifting tube can be manoeuvred by means of the vacuum source so that the tube is compressed along its length when lifting an object, so that the lifting tube is concentrated at its point of suspension, and the tube is extended when lowering the object. For this purpose, the lifting tube usually is constituted of a wire frame in the form of a helical spring, usually called a helical frame, and a cover of a substantially airtight, flexible material enclosing the frame.

In one type of vacuum tube lift devices, the lifting tube is provided with a lifting attachment in the form of a suction foot, utilizing the vacuum in the lifting tube for suctioning onto an object which is to be lifted. Such a lifting device has the advantage that an object which is to be lifted can be attached to and released from, respectively, the lifting tube in a simple and reliable way by means of regulating the pressure inside the lifting tube and the suction foot.

Regardless of the selection of lifting attachment, however, the above-described vacuum tube lift device has the disadvantage that it has a large installation height in relation to the lifting height capacity. The lifting tube can be compressed to a smallest possible length. The length of the lifting tube in a state of maximum compression, the so called compressed length, and the desired effective lifting height substantially make up the total installation height of the lifting device. The relatively large compressed length, usually amounting to approx. 25-30% of the installation height, implies that a lifting device of the type in question cannot be used in many spaces having a ceiling height which is too low in relation to the desired lifting height capacity.

There is another type of vacuum tube lift devices in which the lifting tube instead is arranged horizontally and is connected to an additional vertical component in order to take care of the vertical lifting movement. This additional component can be a wire being provided with a hook, or the like, for coupling to a load. In order to achieve the vertical movement, the wire is arranged to travel over a pulley or the like.

Such a device, however, has the disadvantage that it instead occupies a large space in the horizontal plane, as the entire length of the lifting tube has to be oriented horizontally. This limits the possibility to get the desired working areas in the horizontal plane, since the long lifting tube will be an obstacle in certain positions. The lifting device becomes ungainly, and thereby slower and less flexible to work with.

Another disadvantage with such a device is that a lifting attachment in the form of a suction foot cannot be used without special arrangements. The safety of vacuum tube lift devices is based upon the fact that the vacuum level in the suction foot is the same as in the lifting tube. In this way, it is ensured that there is always a sufficient suction force between the suction foot and the object which is to be lifted.

In conventional vertical vacuum tube lift devices, this is accomplished by means of the suction foot being connected to the vacuum in the lifting tube without any flow restrictions between the lifting tube and the suction foot. Therefore, the vacuum level will always be substantially the same both in the suction foot and the lifting tube.

In a vacuum tube lift device having a horizontally arranged lifting tube, the suction foot is connected to the wire and located at a relatively large distance from the lifting tube, implying, on one hand, that relatively long vacuum lines are required between the suction foot and the lifting tube, and, on the other hand, that a time delay is created before the vacuum in the lifting tube and the vacuum in the suction foot have assumed the same level. In certain cases, the vacuum levels never assume the same level, e.g. when “leaking” goods are lifted. In that case, the flow restriction between the suction foot and the lifting tube, being caused by a pressure drop of the vacuum lines, results in the vacuum level in the suction foot always being lower than in the lifting tube, since the air leaking in reaches the suction foot before it reaches the lifting tube via the vacuum lines. The result of the foregoing can be that the suction force in the suction foot becomes too low in relation to the lifting force so that the suction foot comes loose from the goods which are to be lifted.

In order to solve the problem with a vacuum level which is too low in the suction foot, the device can be provided with a valve arrangement, by means of which the vacuum level in the suction foot is increased before it is increased in the lifting tube and reduced in the lifting tube before it is reduced in the suction foot, respectively. This design however, is relatively complicated in comparison to a conventional vertical vacuum tube lift device, and because of the long vacuum lines the device reacts more slowly to the control commands from an operator than what is the case with a conventional vertical vacuum tube lift device. The reason for this is the long vacuum lines which bring about a flow restriction, said flow restriction in its turn delaying the vacuum level from assuming the same value in the entire system.

### OBJECT OF THE INVENTION AND SUMMARY OF THE INVENTION

One object of the invention is to provide a vacuum tube lift device of the kind described by way of introduction, said vacuum tube lift device having a design implying that the device can be adapted in a flexible way to different installation height requirements both in the vertical plane and the horizontal plane and/or to different lifting operations.

This object is achieved by means of a vacuum tube lift device according to claim 1.

Since the device includes at least one supporting unit providing at least one point of support, and at least one extendable and retractable portion of the lifting tube is arranged to support itself on the point of support and to travel over the point of support during an extending or retracting movement of the lifting tube, for movement of said extendable and retractable portion in a first direction on a first side of the point of support and in a second direction, being different from the first direction, on a second side of the point of support, the extension and position of the lifting tube can be adapted to the conditions of the environment in a flexible way. For example, if desired, the compressed length can be distributed over a horizontally located portion of the lifting tube and a vertically located portion of the lifting tube. Also in the case when the entire compressed length is positioned in a horizontally located portion of the lifting tube in order to create a minimum vertical installation height of the device, the lifting tube can be compressed and extended both during the vertical and the horizontal movement of the lifting tube, implying that the horizontal length of the device does not have to amount to the effective lifting distance and the compressed length, but the horizontal length of the device can be of the same magnitude as the compressed length of the lifting tube.

Furthermore, the device according to the invention has the advantage that it, without any special arrangements, can be provided with a suction foot being in direct connection with the lifting tube. In the same way as conventional lifting devices having vertical lifting tubes, it can utilize the proximity of the suction foot to the lifting tube in order to obtain the same vacuum level both in lifting tube and suction foot without any time delay. In this way, a sufficiently large suction force can always be ensured between the suction foot and the lifted object, without providing the design with any complicated valve arrangements and separate vacuum lines.

The invention also relates to a method for movement of a load by means of a vacuum tube lift device.

Other advantageous features and functions of different embodiments of the invention are evident from the following description and dependent claims.

### BRIEF DESCRIPTION OF THE DRAWING FIGURES

With reference to the attached drawings, a detailed description of exemplifying embodiments of the invention follows below.

In the drawings:

FIG. 1 is a perspective view of a vacuum tube lift device according to the invention;

FIG. 1a is a schematic view of a device according to the invention;

FIG. 1b is a cross-sectional view of a supporting unit of the device according to FIG. 1;

FIG. 2 is a perspective view of a variant of the device according to the invention;

FIG. 2b is a perspective view in which the device of FIG. 2 is shown in a retracted state;

FIG. 3 is a perspective view of another variant of the device according to the invention;

FIG. 4 is a perspective view of another variant of the device according to the invention;

FIG. 5 is a perspective view of another variant of the device according to the invention;

FIG. 5b is a plan view of a supporting unit of the device according to FIG. 5; and

FIG. 6 is a cut schematic view of another variant of the device according to the invention.

### DETAILED DESCRIPTION OF PREFERRED EMBODIMENTS OF THE INVENTION

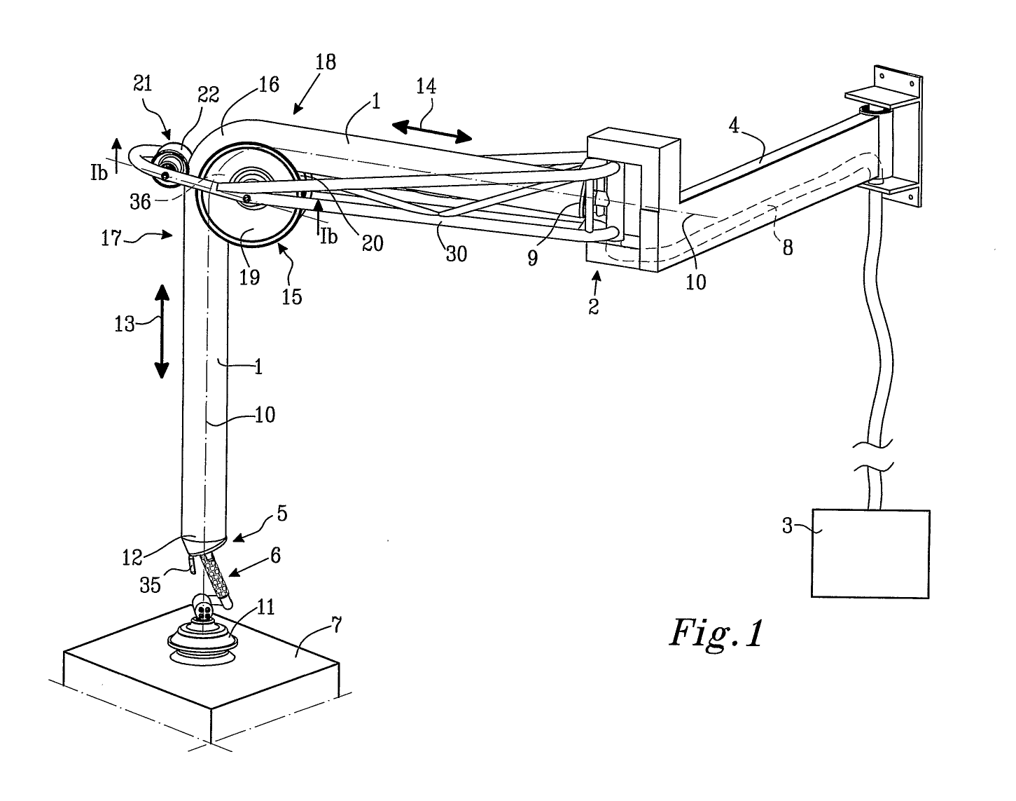

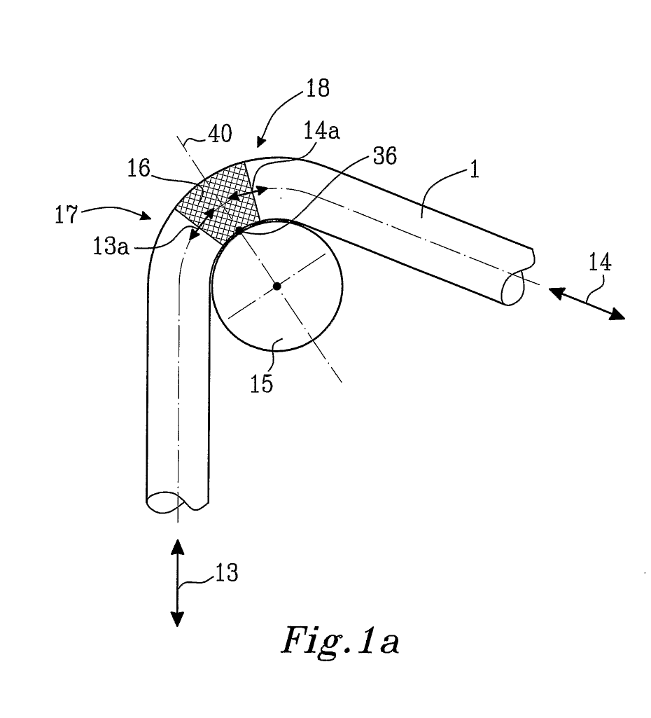

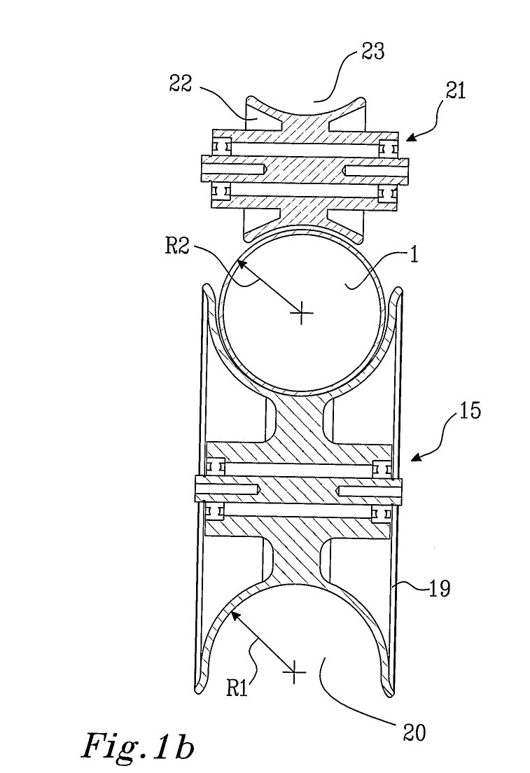

FIG. 1 illustrates a vacuum tube lift device comprising a lifting tube 1 which, at a first end 2, is connected to a vacuum source 3 and attached to a bracket 4. As illustrated, the bracket 4 can be articulated at its point of attachment, so that the bracket, and thereby the lifting tube 1, can be pivoted around the point of attachment of the bracket. At the second free end 5 of the lifting tube 1, a means 6 for coupling the lifting tube 1 to a load 7 is arranged. In the illustrated embodiment, the lifting tube 1 is connected to a vacuum source 3 (illustrated schematically) via the bracket 4, by means of the bracket 4 internally having a hose 8 or a duct interconnecting the lifting tube 1 and the vacuum source 3. The vacuum source can be of the type utilizing an ejector, a pump and/or a fan or of another type and, accordingly, the invention is applicable together with different types of vacuum sources. Preferably, the vacuum source is connected at the first end 2 (as illustrated) or at the second end 5. When using an ejector for producing a vacuum, the ejector is advantageously connected in the vicinity of the second free end 5.

Furthermore, the device preferably comprises a means 9 comprising a ball bearing or the like for supporting the first end 2 of the lifting tube in bearings at the bracket 4 so that the lifting tube 1 can be pivoted around its longitudinal axis 10 relative to the bracket 4. In a corresponding way, the second end 5 of the lifting tube 1 is connected to the coupling means 6, which can include a control member 35 and a suction foot 11 or the like, preferably via a means 12 including a ball bearing, or the like, for supporting the second end 5 of the lifting tube in bearings at the coupling means 6, so that the lifting tube 1 can be pivoted around its longitudinal axis 10 relative to the coupling means 6.

Accordingly, in the example illustrated in FIG. 1, the suction foot 11 is connected to the vacuum source 3 via the lifting tube for regulating the pressure inside the suction foot. Even if it is advantageous in certain cases that the coupling means 6 includes a suction foot 11, it should be emphasized that the invention does not require the use of a suction foot, but can be applied together with an arbitrary coupling means such as, for example, a suction cup, hook, or the like.

The lifting tube is extendable and retractable (see arrows 13, 14) in its longitudinal direction in order to achieve an extending or retracting movement of the lifting tube 1 for movement of a load 7 by means of regulating the pressure inside the lifting tube 1. The fact that the upwardly directed force, which is generated by the pressure of the lifting tube being lower than of the environment, is larger than the downwardly directed force acting on the object and originating from gravitation, is utilized when retracting the lifting tube 1. Inversely, an extension of the lifting tube is obtained if the downwardly directed force on the lifted object 7 is larger than the upwardly directed force being generated by the lifting tube 1. The loads being lifted with the device according to the invention usually have a weight within the interval from approx. 0.5 kg up to 500 kg. As a rule, a lifting tube having a circular cross-section with a diameter within the interval 20 mm to 300 mm is used for carrying out the lifting operations, and the length of the lifting tube in an extended state is preferably within the interval from a few decimetres up to 5 meters.

The device according to the invention comprises a supporting unit 15 exhibiting at least one point of support 36, and at least one extendable and retractable portion 16 of the lifting tube 1 is arranged to support itself on the point of support 36 of the supporting unit and to travel over the point of support 36, during an extending or retracting movement of the lifting tube 1, for movement of said extendable and retractable portion 16 in a first direction 13a on a first side 17 of the point of support 36 and in a second direction 14a, being different from the first direction 13a, on a second side 18 of the point of support 36. See also FIG. 1a where said directions 13a, 14a are illustrated.

FIG. 1a can be seen as schematic partial view of FIG. 1, but also constitutes a general schematic illustration of a device according to the invention. For reasons of illustration, the extendable and retractable portion 16 of the lifting tube 1 is dash-dotted and abuts against the point of support 36 of the supporting unit 15. When extending and/or retracting the lifting tube 1, the portion 16 will move in different directions on each side of the point of support 36. On a first side 17 of the point of support 36, the portion 16 will move in a first direction 13a, and on a second side 18 of the point of support 36, the portion 16 will move in a second direction 14a, being different from the first direction 13a. In this case, the first side 17 can be defined as the side being located below a line 40 extending between the centre of the supporting unit 15 and the point of support 36. The second side 18 can be defined as the side being located above said line 40. It should be noted that the extendable and retractable portion 16 very well can move in several different directions while abutting against the supporting unit 15 and being moved around the supporting unit 15, and that at least some of the movement directions 13a, 14a of the portion 16 being closest to the point of support 36 do not have to coincide with the main extension directions 13, 14 of the lifting tube 1. The device according to the invention can be designed in a number of different ways with the lifting tube arranged in arbitrary main directions 13, 14. Preferably, the lifting tube is arranged so that, during at least some portion of a lifting operation, a significant portion of the lifting tube is located on a first side 17 of the point of support at the same time as a significant portion of the lifting tube is located on a second side 18 of the point of support.

When using a helical frame in the lifting tube 1 and a supporting unit 15 in the form of a pivotable roller, or a pivotable wheel, or the like, a lifting tube 1 being pivotally supported in bearings at the ends by means of e.g. ball bearings, as described in the foregoing, is particularly advantageous, since such a bearing arrangement of the lifting tube 1 counteracts an undesired relative torsion, and wear, between the lifting tube 1 and the supporting unit 15.

Even if the lifting tube 1 of the illustrated embodiment is arranged at a bracket 4, to which also the supporting unit 15 is attached via brace means 30, it should be emphasized that the lifting tube 1 can be attached in another way by means of an appropriate suspension attachment, and that different suspension attachments can be used for the lifting tube 1 as well as for the supporting unit 15. The lifting tube and/or the supporting unit can be attached to a fixed or mobile unit. A mobile unit can be, for example, a pivotable arm or an overhead crane system. For attachment to a fixed unit, conveniently some kind of bracket being arranged on a floor, a wall, or suspended from a ceiling, is used. The lifting tube and/or the supporting unit could also be arranged substantially directly in a ceiling or on a wall and/or directly on the vacuum source. Furthermore, the vacuum tube lift device can be installed indoors or outdoors, and in a room as well as in a vehicle.

The supporting unit preferably has a rotatable wheel 19. Conveniently, the rotatable wheel 19 is provided with a groove 20 for receiving the lifting tube 1. See also drawing FIG. 1b. Preferably, the groove 20 is adapted to the shape and dimension of the cross-section of the lifting tube 1 for receiving the lifting tube 1. This means, for example, that the groove 20 can exhibit a substantially semicircular cross-section having a radius R1 being slightly larger than the radius R2 of the preferably circular cross-section of the lifting tube 1. Naturally, within the scope of the invention, it is also possible to arrange other types of supporting units, such as a simple sliding surface, or a roller belt, etc.

In order to counteract, at least to some extent, that the lifting tube 1 deviates from its position at the supporting unit 15, the device can include a counter-support 21, being arranged on the opposite side of the lifting tube 1 in relation to the supporting unit 15. Such a counter-support 21 can comprise e.g. a rotatable counter-supporting wheel 22, preferably being provided with a groove 23 for receiving the lifting tube 1. In another design, the counter-supporting wheel could be suspended so that it abuts against the lifting tube 1 by means of a spring force in order to obtain a flexible counter-support for the lifting tube 1.

The device illustrated in FIG. 1 has a rotatably arranged, first wheel 19, for enabling that the lifting tube 1 changes direction, from a substantially horizontal 14 direction of the portion of the lifting tube 1 being located between the wheel 19 and the position of attachment of the lifting tube at the bracket 4 to a substantially vertical direction 13 of the portion of the lifting tube 1 being located between the wheel 19 and the load 7. This implies that said extendable and retractable portion 16 is arranged for movement substantially vertically 13 on the first side 17 of the supporting unit 15, being closest to the load 7, and for movement substantially horizontally 14 on the second side 18 of the supporting unit 15, being closest to the bracket 4. A counter-supporting wheel 22 is arranged on the opposite side of the lifting tube 1 in relation to the rotatable wheel 19 of the supporting unit 15, and both wheels 19, 21 are provided with grooves 20, 23 being adapted for receiving the lifting tube 1. In other words, at least a portion 16 of the lifting tube 1 is arranged for a substantially vertical movement during a certain portion of the lifting movement and for a substantially horizontal movement during another portion of the lifting movement.

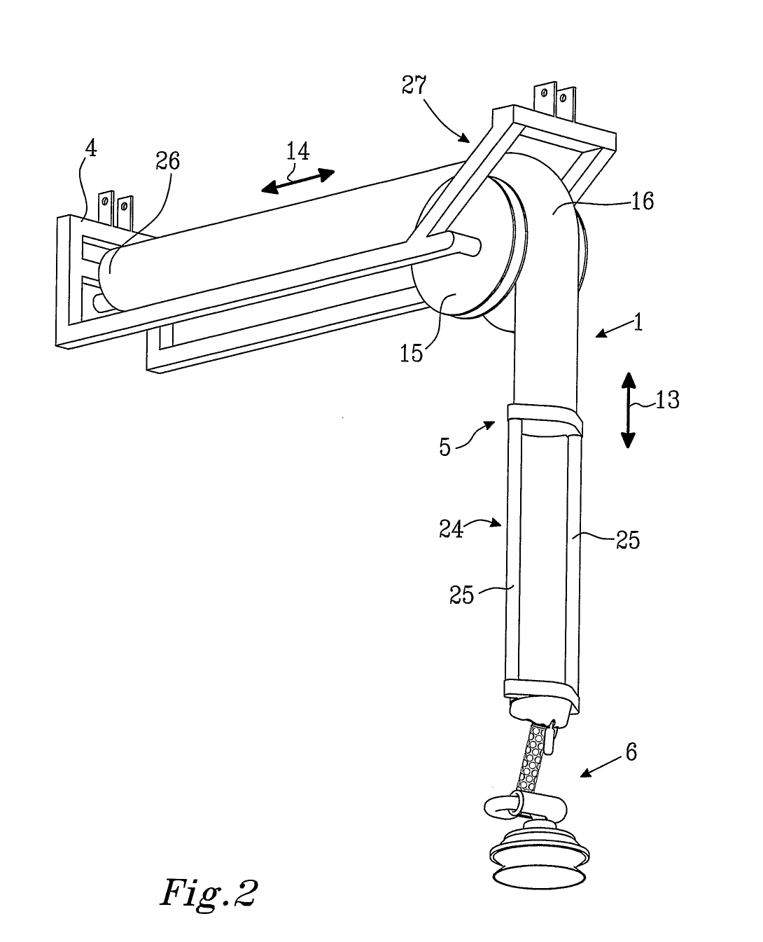

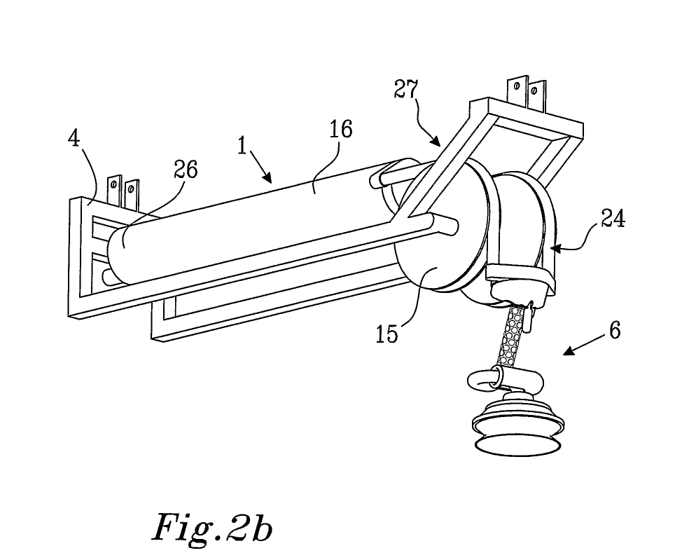

FIGS. 2 and 2b illustrate a variant of the device according to the invention in which the lifting tube 1 can assume a position implying that the lifting tube 1 itself has no contact with the supporting unit 15 during a certain portion of the lifting movement. In this case, an additional unit 24 is arranged at the second end 5 of the lifting tube 1, between the lifting tube and the coupling means 6. This unit 24 can exhibit one or several ropes, wires or the like or, as illustrated, one or several vacuum hoses 25 which at the same time are dimensioned for transferring a tension load. The two vacuum hoses 25 take care of establishing a connection between the suction foot 11 and the lifting tube, but are not extendable and retractable per se, in the same way as is the case with the lifting tube. In relation to the lifting tube, these hoses are stiff and incompressible, and are arranged for transferring the force from the load via the material of the hoses.

In the retracted condition of the lifting tube 1 illustrated in FIG. 2b, the lifting tube has no contact with the supporting unit 15, since the distance between the point of attachment 26 for the lifting tube 1 at the bracket 4 and the position 27 of the supporting unit 15 exceeds the minimum compressed length of the lifting tube 1. Nevertheless, according to the invention, the extendable and retractable portion 16 of the lifting tube 1 will support itself on at least one point of support of the supporting unit 15 during a portion of the movement of the lifting tube, and be moved in different directions 13, 14 on different sides of the point of support and the supporting unit 15, since the maximum extended length of the lifting tube 1 exceeds the distance between the position of attachment 26 for the lifting tube at the bracket 4 and the position 27 of the supporting unit 15.

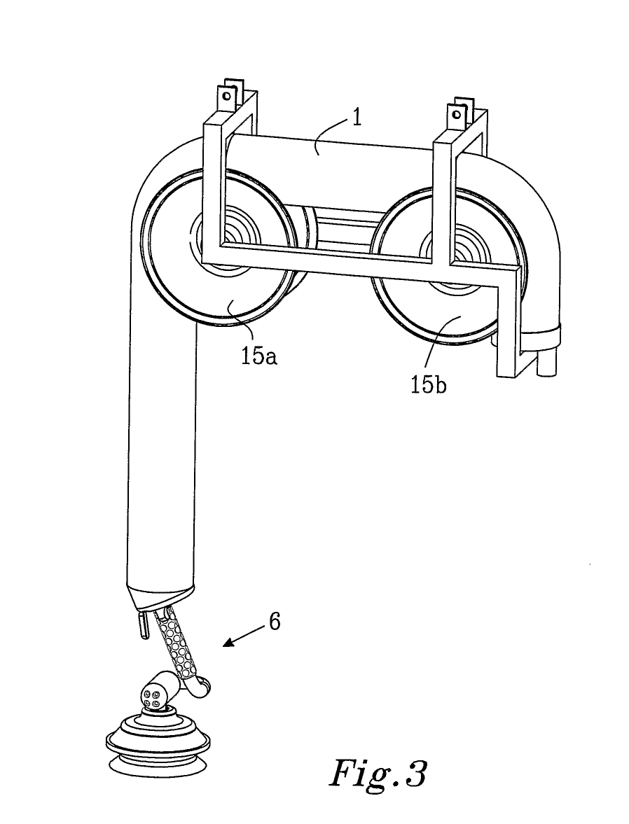

FIG. 3 illustrates a variant of the device according to the invention comprising two supporting units 15a, 15b. This implies that the lifting tube 1 changes main extension direction at two positions. Naturally, the device can comprise one, two, or several supporting units, depending on the function which is desired to achieve. Furthermore, the location of the supporting units and the, length of the lifting tube can be adapted to each other so that a certain extendable and retractable portion of the lifting tube 1 will support itself against different supporting units during different portions of the lifting movement and travel over different supporting units for movement of said extendable and retractable portion in a first direction on a first side of a point of support of the respective supporting unit, and in a second direction, being different from the first direction, on the second side of the point of support of the respective supporting unit.

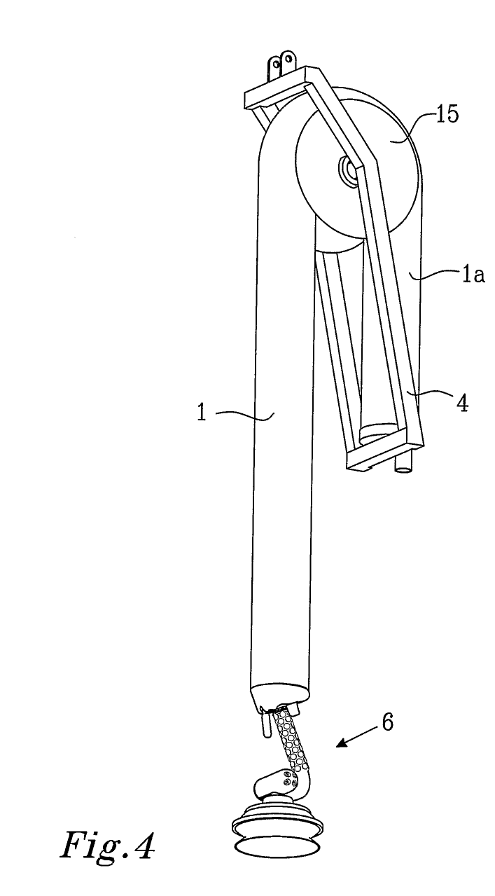

FIG. 4 illustrates a variant of the device according to the invention utilizing a supporting unit 15 corresponding to the one shown in FIG. 1. In this embodiment, however, the attachment of the lifting tube 1 to the bracket 4 is different in relation to the supporting unit 15, implying that the change of direction of the lifting tube 1 at the supporting unit 15 becomes different. If, as illustrated, the bracket 4, the lifting tube 1 and the supporting unit 15 are positioned in relative positions so that the portion of the lifting tube la being arranged between the bracket 4 and the supporting unit 15 has an extension from the bracket 4 substantially vertically upwards towards the supporting unit, a change of direction of 180° will be obtained at the supporting unit 15. Accordingly, for one and the same supporting unit 15, the main extension direction of the lifting tube 1, and the change of main extension direction at the supporting unit 15, can be varied by means of different selections of the position of attachment of the lifting tube 1 at the bracket 4 in relation to the location of the supporting unit 15.

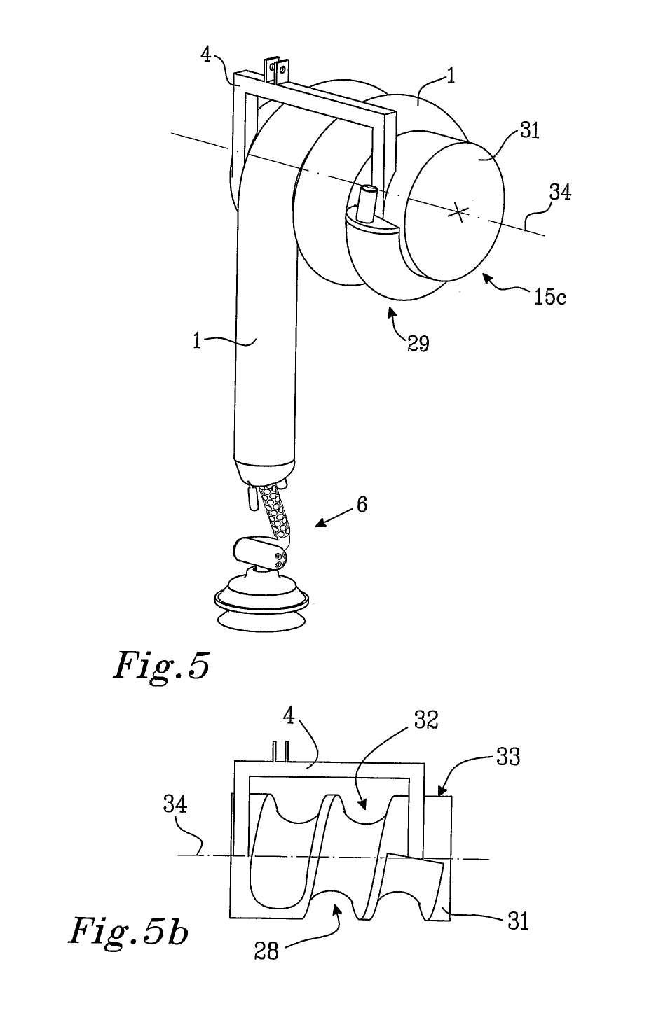

FIGS. 5 and 5b (FIG. 5b shows only the supporting unit in order to illustrate the design of the supporting unit) illustrate a variant of the device according to the invention in which the supporting unit 15c has a means 28 for receiving the lifting tube 1 so that the lifting tube assumes a helical 29 extension around the supporting unit 15c or, in other words, that the lifting tube 1 forms a helical spiral 29 around the supporting unit 15c. For this purpose, the supporting unit can be designed as a drum 31 or the like, said drum 31 being provided with a helical recess 32 in its radial circumference 33. By means of the recess, a compartment is created for the lifting tube 1, for accommodating the lifting tube in a position implying that the lifting tube assumes the shape of a spiral extending along the longitudinal axis 34 of the drum. An alternative solution is to use a smooth drum instead, on the outside of which a helical coil forming an elevation is applied for achieving a corresponding compartment for the lifting tube 1 in the supporting unit. When using the above-mentioned receiving means 28 of the supporting unit 15c, the lifting tube 1 will extend and contract, respectively, while the lifting tube all the time is arranged as a helical spiral around the supporting unit 15c. During an extending or retracting movement of the lifting tube, several portions of the lifting tube 1 will support themselves on a point of support of the supporting unit and travel over the point of support in order to move in a first direction on a first side of the point of support and in a second direction, being different from the first direction, on the second side of the point of support. The supporting unit 15c can be said to exhibit a number of positions, each functioning as a point of support of its own for one extendable and retractable portion of the lifting tube 1.

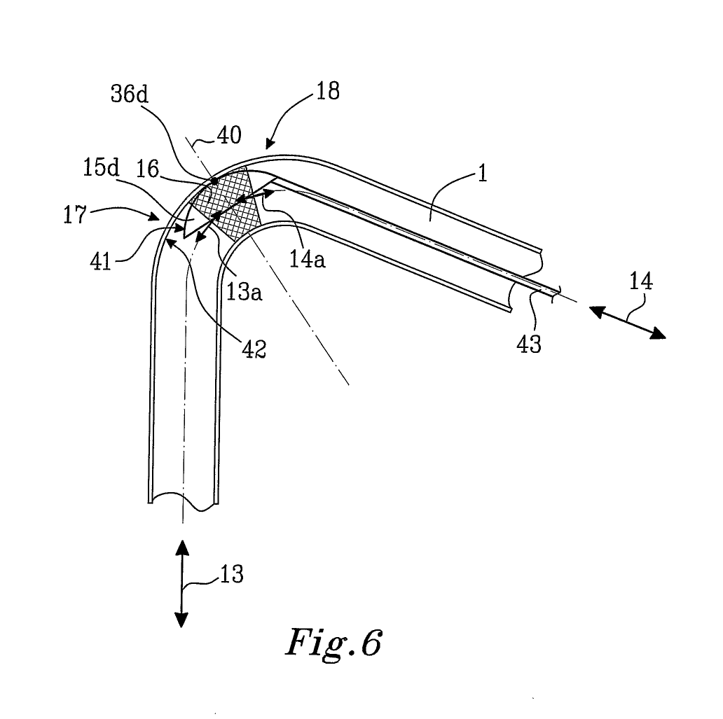

FIG. 6 illustrates another embodiment of the device according to the invention. In this design, at least the portion of the supporting unit 15d exhibiting said at least one point of support 36d is arranged inside the lifting tube 1. A brace means 43, or the like, is arranged for positioning the supporting unit 15d, and thereby the point of support 36d, inside the lifting tube 1. The inside 42 of the lifting tube 1 will support itself on the supporting unit 15d and the point of support 36d. Even though the supporting unit 15d in FIG. 6 has a sliding surface 41, also other designs of the supporting unit, such as wheels, rollers etc., as described previously, could be applied to this embodiment exhibiting a supporting unit being arranged internally in the lifting tube. Said at least one extendable and retractable portion 16d of the lifting tube 1 will support itself on the point of support 36d and travel over the point of support 36d for movement of said extendable and retractable portion 16 in a first direction 13a on a first side 17 of the point of support 36d and in a second direction 14a, being different from the first direction 13a, on a second side 18 of the point of support 36d.

With reference primarily to FIGS. 1 and 1a, it is described in the following how the vacuum tube lift device according to the invention can be used.

In order to lift the load 7, an operator applies the suction foot 11 onto the load 7, and by means of a control member 35, controlling the vacuum level in the system, a negative pressure is produced in the lifting tube 1 and the suction foot 11, so that the load is suctioned onto the suction foot 11. At a sufficient pressure reduction in the lifting tube 1, the lifting tube will contract and lift the load 7. A contraction of the lifting tube in its longitudinal direction 13, 14 will take place along substantially the entire length of the lifting tube, implying that the portion of the lifting tube being located between the load 7 and the supporting unit 15 will be retracted in a substantially vertical direction and the portion of the lifting tube being located between the supporting unit 15 and the bracket 4 will be compressed in a substantially horizontal direction. During a lifting or lowering movement, a portion of the lifting tube 16 will change movement direction from substantially vertical to substantially horizontal, or vice versa. Accordingly, in accordance with the method according to the invention for movement of a load by means of a vacuum tube lift device exhibiting a lifting tube, at least one extendable and retractable portion 16 of the lifting tube 1 is brought to support itself on a point of support 36 of the supporting unit 15 and to travel over the point of support 36 during an extending or retracting movement of the lifting tube 1. Thereby, said extendable and retractable portion 16 is moved in a first direction 13a on a first side 17 of the point of support 36 and in a second direction 14a, being different from the first direction 13a, on the second side 18 of the point of support 36.

Although the invention primarily is intended for lifting a load, preferably a load being freely suspended from the lifting tube, substantially vertically from a first position to a second, higher position, wherein at least a portion of the lifting tube being closest to the load is positioned substantially vertically, it would be possible to arrange the lifting tube for lifting a load in another direction. When using a supporting plane on which the load can support itself during the lifting movement, it is possible to drag a load along any surface, provided that the rest surface has a perpendicular with an upwardly directed component.

In addition to the ones being described in the present application, there are naturally other ways of designing the device according to the invention within the scope of the inventive idea, and it is emphasized that the invention is limited only to the scope of protection being defined in the following claims.

1. A vacuum tube lift device, comprising:
a lifting tube, said lifting tube having;
a first end for attachment of the lifting tube; and
a second end for connection to a means for coupling the lifting tube to a load, wherein the lifting tube is adapted for connection to a vacuum source and is extendable and retractable in order to achieve an extending or retracting movement of the lifting tube for movement of the load by means of regulating the pressure inside the lifting tube, wherein the device comprises a supporting unit providing a point of support, and that an extendable and a retractable portion of the lifting tube is arranged to support itself on the point of support and to travel over the point of support during an extending or a retracting movement of the lifting tube, for movement of said extendable and retractable portion in a first direction on a first side of the point of support and in a second direction, being different from the first direction, on a second side of the point of support.

2. Vacuum tube lift device according to claim 1, wherein a first portion of the lifting tube is arranged for movement in a substantially vertical direction.

3. Vacuum tube lift device according to claim 1, wherein a second portion of the lifting tube is arranged for movement in substantially horizontal direction.

4. Vacuum tube lift device according to claim 1, wherein said supporting unit comprises a rotatable wheel providing said point of support.

5. Vacuum tube lift device according to claim 4, wherein the rotatable wheel has a groove for receiving the lifting tube.

6. Vacuum tube lift device according to claim 1, wherein said supporting unit comprises a sliding surface providing said point of support.

7. Vacuum tube lift device according to claim 1, wherein the device comprises a counter-support, arranged on an opposite side of the lifting tube in relation to said supporting unit, in order to counteract that the lifting tube deviates from its position at said supporting unit.

8. Vacuum tube lift device according to claim 7, wherein the counter-support includes a rotatable counter-supporting wheel.

9. Vacuum tube lift device according to claim 8, wherein the counter-supporting wheel has a groove for receiving the lifting tube.

10. Vacuum tube lift device according to claim 1, wherein the supporting unit has a means for receiving the lifting tube so that the lifting tube assumes a helical extension around the supporting unit.

11. Vacuum tube lift device according to claim 10, wherein the supporting unit is a drum provided with a helical recess in its radial circumference.

12. Vacuum tube lift device according to claim 1, wherein the point of support is arranged on an inside the lifting tube for supporting the lifting tube via the inside of the lifting tube.

13. Vacuum tube lift device according to claim 1, wherein the device comprises two or more supporting units for obtaining different directions of the lifting tube on different sides of the respective supporting unit.

14. Vacuum tube lift device according to claim 1, wherein the device comprises a first means, for supporting the first end of the lifting tube at a first additional unit, so that the lifting tube can be pivoted around its longitudinal axis relative to said first additional unit and wherein the means for supporting the first end comprises a ball bearing.

15. Vacuum tube lift device according to claim 1, wherein the device comprises a second means, for supporting the second end of the lifting tube at a second additional unit, so that the lifting tube can be pivoted around its longitudinal axis relative to said second additional unit and wherein the means for supporting the second end comprises a ball bearing.

16. Vacuum tube lift device according to claim 1, wherein the device comprises the vacuum source to which the first end or the second end of the lifting tube is connected for regulating the pressure inside the lifting tube.

17. Vacuum tube lift device according to claim 1, wherein device comprises a means, for coupling the lifting tube to a load arranged at the second end of the lifting tube.

18. Vacuum tube lift device according to claim 17, wherein the coupling means comprises a suction foot.

19. Vacuum tube lift device according to claim 18, wherein the suction foot is connected to the vacuum source via the lifting tube for regulating the pressure inside the suction foot.

20. A system for movement of a load by means of a vacuum tube lift device comprising:
a lifting tube connected to a vacuum source, and
coupled to a load at one end, wherein the lifting tube is extendable and retractable in order to achieve an extending or retracting movement of the lifting tube for movement of the load by means of regulating the pressure inside the lifting tube, wherein an extendable and a retractable portion of the lifting tube is brought to support itself on a point of support of a supporting unit and to travel over the point of support during the extending or retracting movement of the lifting tube, in order to move said extendable and retractable portion in a first direction on a first side of the point of support and in a second direction, different from the first direction, on a second side of the point of support.

21. A lift device, comprising:
a vacuum source;
a lifting tube, coupled to the vacuum source, the lifting tube comprising an end configured to couple to a load, wherein the lifting tube is configured to extend and retract along its length and move in first and second directions; and
a supporting unit for supporting the lifting tube.
